(19) United States
(12) Patent Application Publication
(10) Pub. No.: US 2014/0176990 A1
(43) Pub. Date: Jun. 26, 2014

(54) PRINTER

(71) Applicants: David Block, El Cerrito, CA (US); Vladimir Buzuev, Castro Valley, CA (US)

(72) Inventors: David Block, El Cerrito, CA (US); Vladimir Buzuev, Castro Valley, CA (US)

(21) Appl. No.: 13/878,816

(22) PCT Filed: Oct. 11, 2011
(86) PCT No.: PCT/US2011/055720

§ 371 Date: Mar. 11, 2014

Related U.S. Application Data
(60) Provisional application No. 61/392,165, filed on Oct. 12, 2010.

(51) Int. Cl. G06F 3/12

(52) U.S. Cl. CPC G06F 3/1293
USPC 358/1.15

(57) ABSTRACT

A label printer comprising: a connector configured to allow said label printer to be connected to a PC; at least one memory; at least one processor; said label printer being configured to function as a Human Interface Device (HID) when connected to said PC.

The present invention relates to a label printer, and more particularly to a label printer that can be connected to a PC.

PC-connectable label printers are known. Using such label printers users can create and print labels via an interface on a PC. An example of such a label printer is the Dymo® Label Manager 9000.

Also known are so-called “plug & play” label printers in which the label printer can be connected to a PC for direct printing without the requirement for installing printer drivers on the PC.

An example of such a label printer is shown in EP2053499 (Brother). According to this document the label printer is recognised by a PC to which it is connected as a device of USB mass storage class. With this configuration printing from the PC is enabled even if a printer driver is not installed on the PC. The printer determines what action to take with received files, for example whether to print or store those files, based upon the attributes of those files. According to this document application software is stored on Random Access Memory (RAM) within the label printer. Print files are also stored on this RAM, meaning that it is read/write capable.

EP2113835 (Brother) also discloses a plug & play printer. In this document the printer can operate at any one time in one of two states: a storage device state in which the printer operates as a plug and play printer, or a printer device state in which the printer prints using drivers installed on the PC to which the printer is connected. A switching device enables a user to switch between the storage device state and the printer device state. In other words the printer is recognised by the PC as either a mass storage device or a printer device.

Brother also produce at least two printers, namely the PT-1230PC and PT-2430PC, in which a physical switch is provided to enable a user to switch between the storage device state and the printer device state.

It is also known to store application software on label printer memory, for example on Flash memory. To minimise label printer cost it may sometimes be desirable to use a relatively small Flash memory. This may place constraints on the size of the application software that can be stored on the Flash memory and may limit the features that can be provided with the application software.

Furthermore such Flash memory may have a slow read speed, delaying the start-up time of the printer when connected to a PC.

Accordingly in a first aspect the present invention provides a label printer comprising:

a connector configured to allow said label printer to be connected to a PC; at least one memory; at least one processor; said label printer being configured to function as a Human Interface Device (HID) when connected to said PC.

In another aspect the present invention provides a system comprising a PC and a label printer as set forth in the preceding paragraph.

In another aspect the present invention provides a method of operating a label printer comprising: connecting said label printer to a PC; transferring a label editor program from a memory of said label printer to a memory of said PC; executing said label editor program on said PC; and sending information from said PC to said label printer via a Human Interface Device channel.

In another aspect the present invention provides a label printer comprising: a connector configured to allow said label printer to be connected to a PC; at least one memory; a label editor program stored on said at least one memory; wherein said label editor program is stored in said memory in a compressed state.

In another aspect the present invention provides a label printer comprising: a connector configured to allow said label printer to be connected to a PC; at least one memory; a label editor program stored on said at least one memory; wherein said at least one memory further comprises a launcher application for launching said label editor program when said label printer is connected to said PC.

For a better understanding of the present invention and as to how the same may be carried into effect, reference will now be made by way of example only to the accompanying drawings in which:

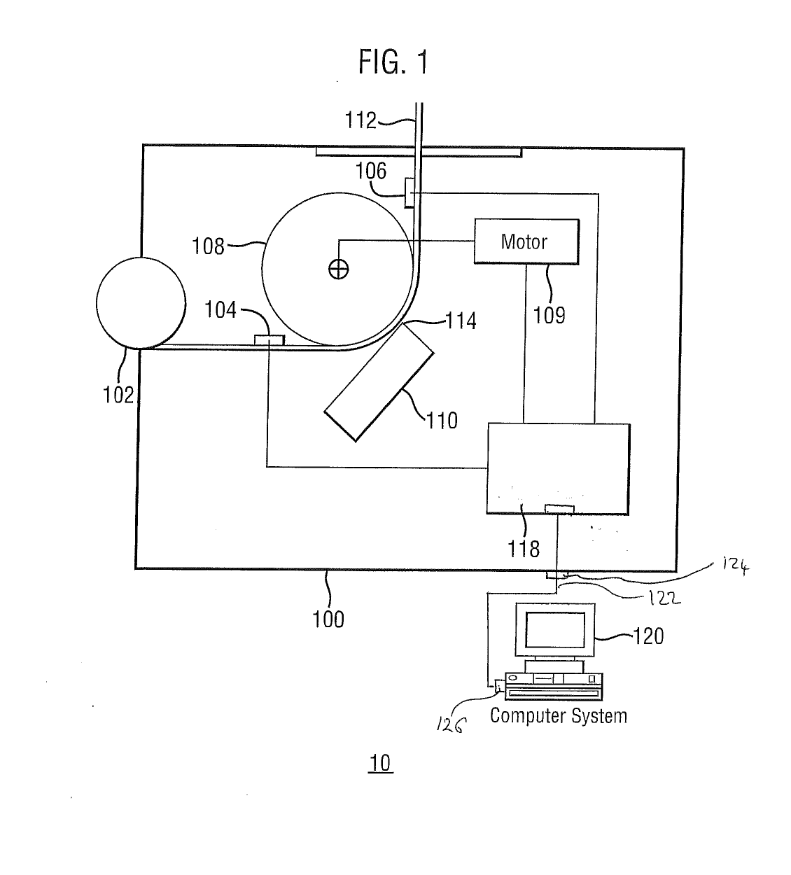

FIG. 1 shows schematically a label printer according to an embodiment, connected to a PC.

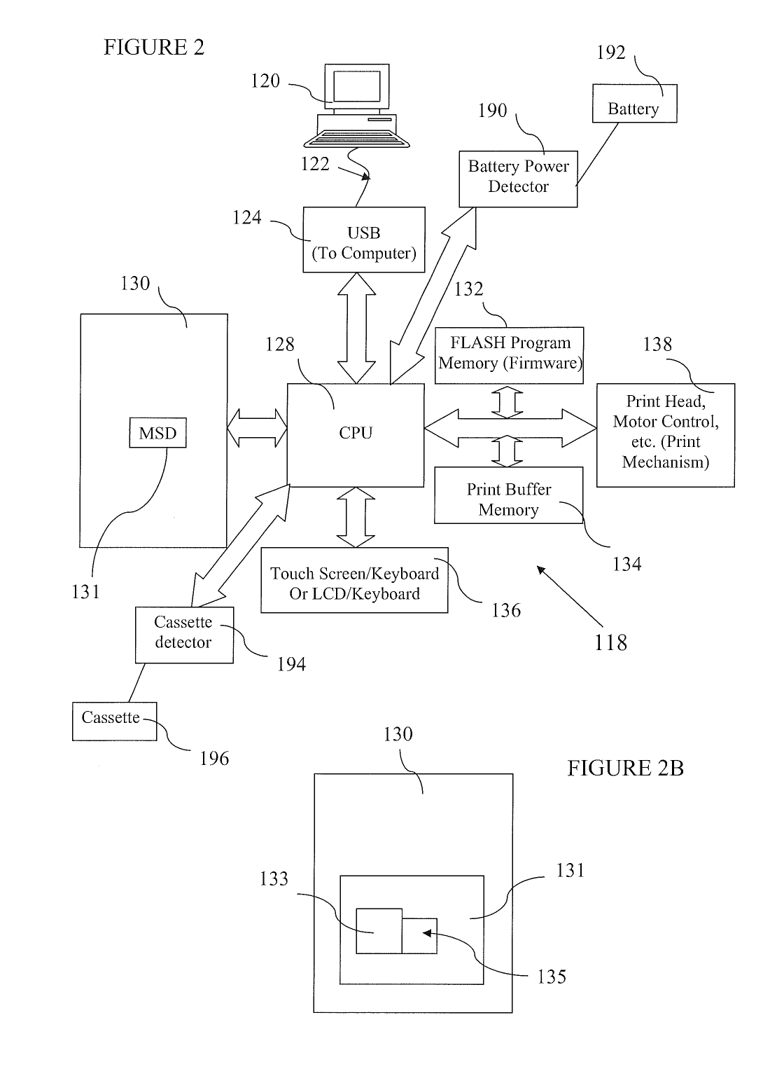

FIG. 2 shows in more detail certain aspects of the label printer of FIG. 1.

FIG. 2B shows in more detail certain aspects of FIG. 2.

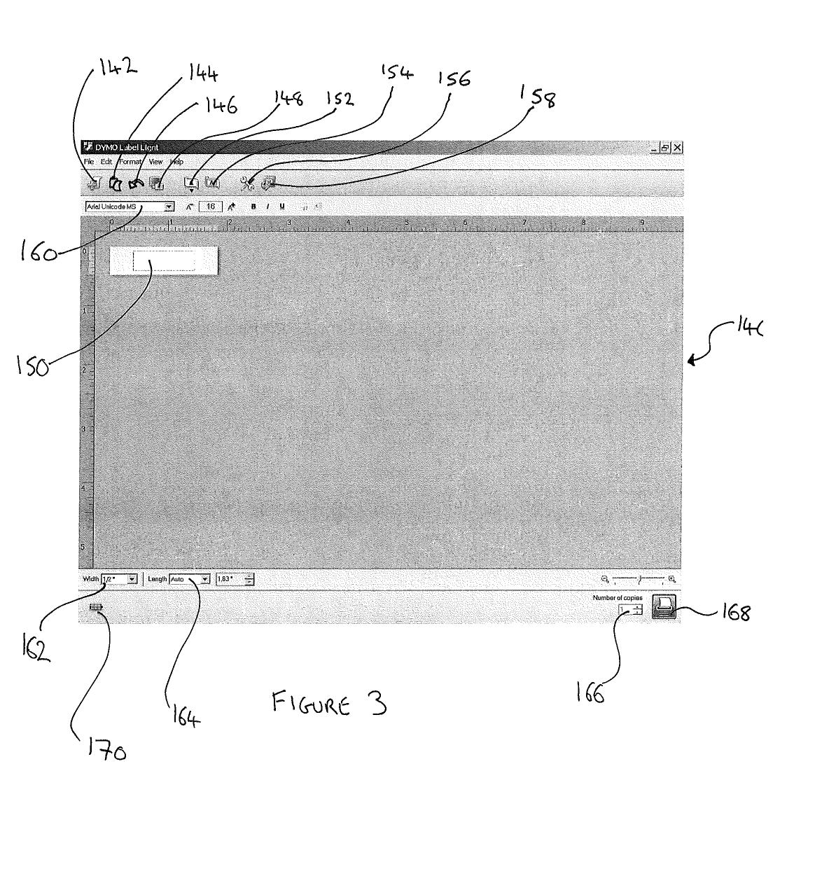

FIG. 3 shows an embodiment of a plug and play user interface.

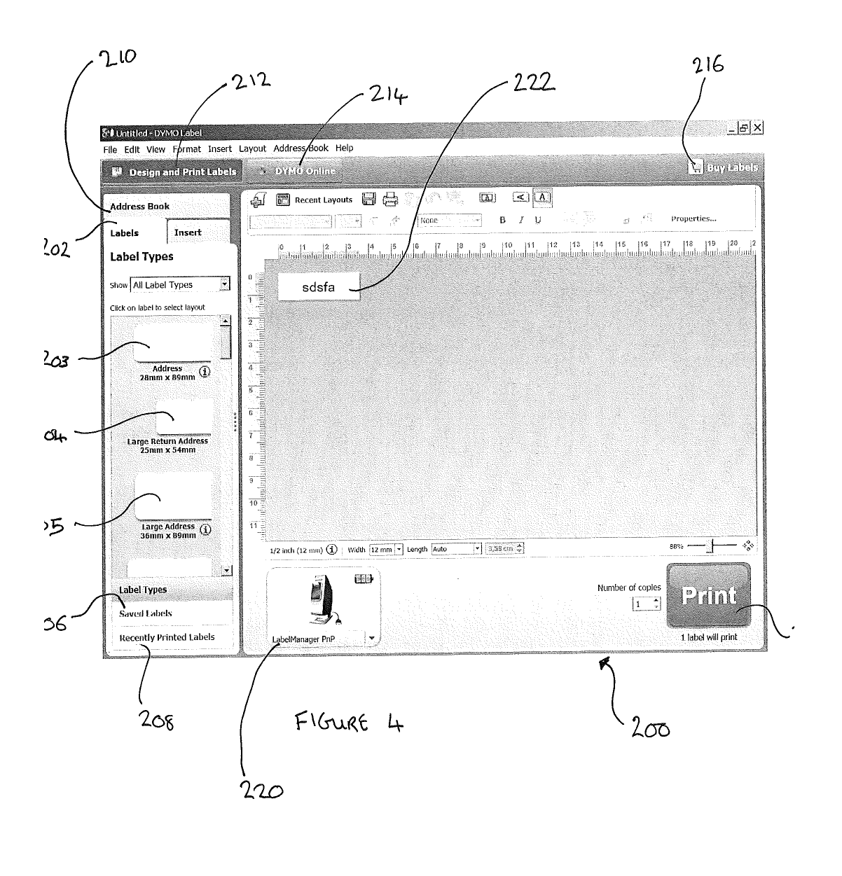

FIG. 4 shows an embodiment of a full printer user interface.

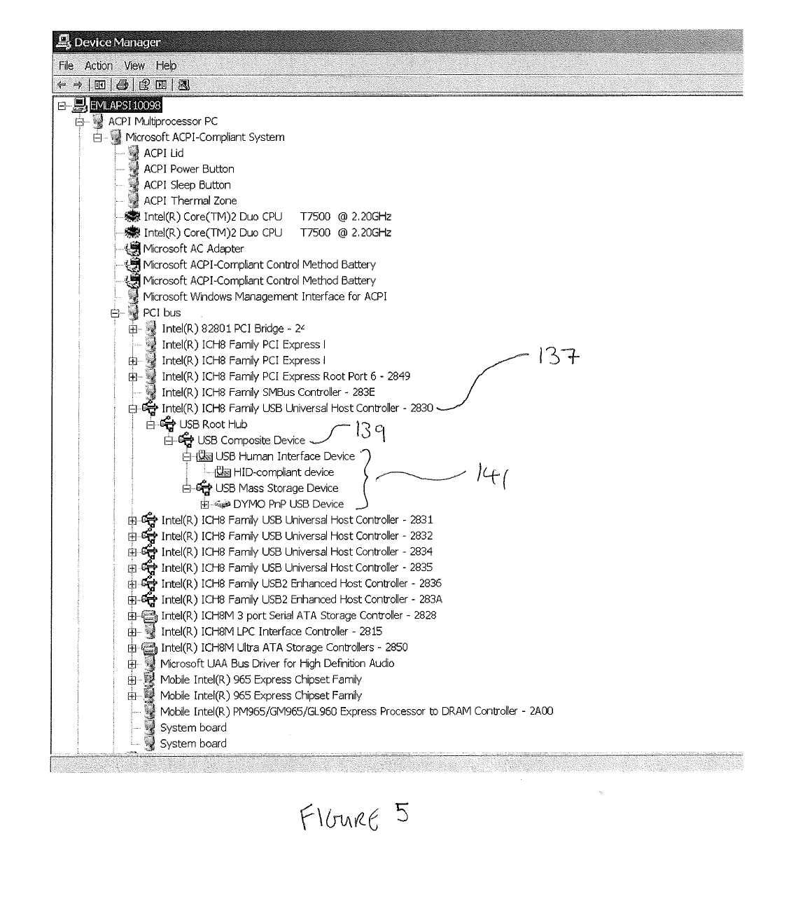

FIG. 5 shows a Windows® Device Manager Hierarchy when a label printer is connected to a PC.

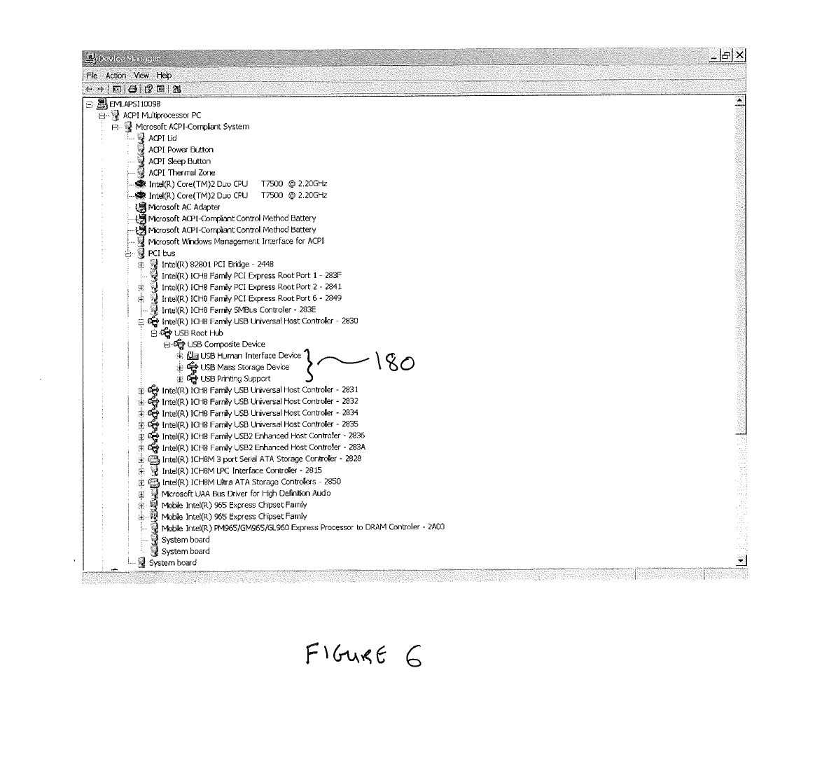

FIG. 6 shows a Windows® Device Manager Hierarchy when a label printer is connected to a PC and printer drivers have been installed.

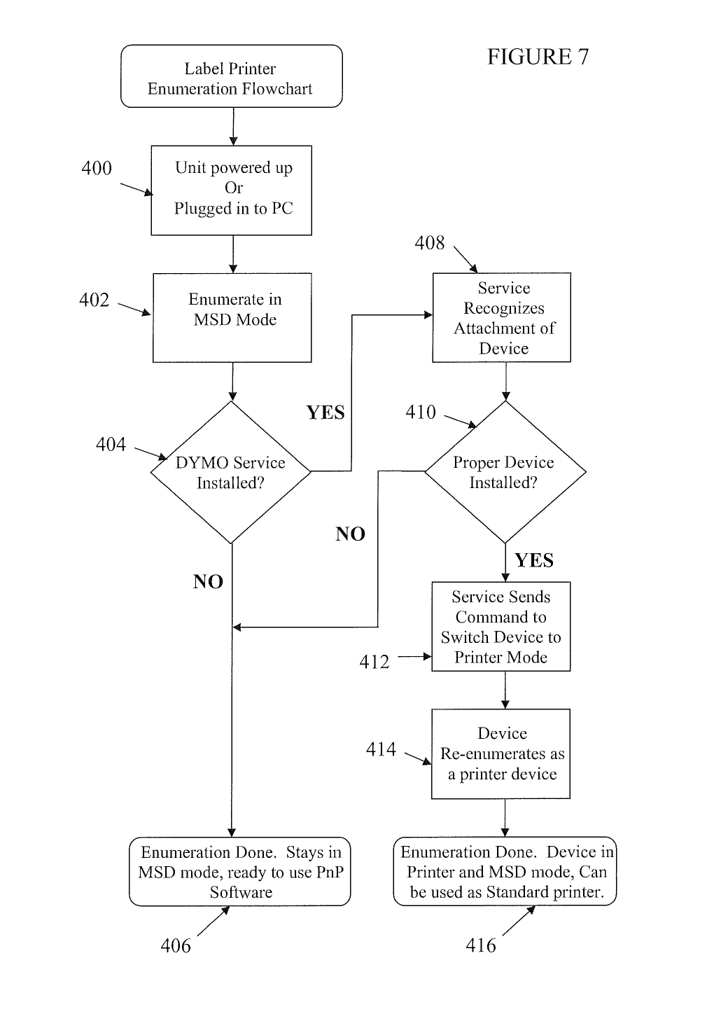

FIG. 7 is a flowchart showing enumeration of a label printer when connected to a PC.

FIG. 1 illustrates a logical view of a label printing system 10. The label printing system 10 includes a label printer shown schematically at 100 and a personal computer (PC) 120.

The label printer 100 accepts label stock 102 and prints information onto labels of the label stock 102.

The label stock 102 includes labels and a stock carrier material. The labels are adhered to the stock carrier material in a manner generally known in the art.

Alternatively the label stock may comprise a supply of continuous tape comprising a backing layer and a print receiving layer. Such continuous tape is cut to a desired length using a cutting mechanism shown schematically at 106.

In this embodiment the label printer 100 includes a top of form (hereinafter “TOF”) sensor 104, a platen 108, a motor 109, a print head 110, and an exit point 112, and hardware 118. The hardware 118 is described in more detail below with respect to FIG. 2.

The TOF sensor 104 detects TOF marks (not shown) and the presence or absence of the label stock 102.

The motor 109 drives the platen 108, such that the platen 108 turns in a clockwise or counter-clockwise direction. Rotation of the platen 108 causes the label stock 102 to advance in a forward direction if the platen 108 rotates counter-clockwise or to advance in a reverse direction if the platen 108 rotates in a clockwise direction.

The print head 110 prints information onto the labels of the label stock 102. The print head 110 is positioned such that the information is printed at a pinch-point 114 of the platen 108 and the print head 110.

The printer 100 is connected to the PC 120 via a USB cable 122 which plugs into a USB slot 124 of the label printer and USB slot 126 of the PC 120. In an alternative embodiment a wireless USB connection can be used, in which case cable 122 is not required.

Via this USB connection the label printer 100 can send information to the PC 120 regarding the types of labels contained on the label stock 102, or where the supply is continuous tape the width of that tape. The label printer 100 can also send information on whether or not the label printer 100 is ready to print, a battery level status and the like. The information determined by the cassette detector can alternatively or additionally be sent. Any other suitable information may additionally or alternatively be sent to the PC. At least some of this information may allows the PC 120 to format print requests for the label printer 100 or even to determine if it may send the requests.

Likewise the PC 120 is capable of sending information to the label printer 100 via USB cable 122, such as print data, firmware updates, and the like.

In one embodiment, the label stock 102 may be contained within a cartridge or case. Use of a cartridge or case containing the label stock 102 allows a user to insert and/or remove labels from the label printer 100 with ease. Once the cartridge or case is inserted into the label printer 100, the label printer 100 begins processing the label stock from the cartridge or case. The label stock 102 is processed through the label printer 100 in substantially the same manner as if the label stock 102 was not contained within the cartridge or case. It should be appreciated that in some embodiments, the label supply is provided in roll form, without the cassette.

The printer hardware 118 is shown in more detail in FIG. 2.

The printer hardware 118 comprises a central processing unit (CPU) 128, Flash storage 130, Flash program memory 132, print buffer memory 134, data entry unit 136 and print mechanism 138.

The Flash storage 130 comprises Mass Storage Device drive 131. Therefore, when the printer 100 is connected to the PC 120, the label printer 100 reports itself to the PC 120 as comprising a USB Mass Storage Device drive.

The hardware 118 further comprises Flash program memory 132, within which the printer firmware is stored.

Print buffer memory 134 temporarily stores queued print data. Once print data in the buffer memory 134 has been printed, it is cleared from the buffer.

The print mechanism is shown generally at 138. The print mechanism 138 includes print head 110 and motor 109 (see FIG. 1).

There is also provided a battery power detector 190 which detects the remaining power of battery 192, which can be reported to the CPU.

There is also provided cassette or label supply detector 194 which can provide the CPU 128 with the status of a cassette or label supply 196 inserted in the label printer. The status could for example be the presence or absence of a cassette/label supply, the type of label/tape, whether the cassette/supply has been correctly inserted, or whether a cassette/supply bay cover has been closed.

As well as being able to enter data via PC 120, a user can enter data (such as alpha-numeric data) using data entry unit 136 which is located on the label printer 100. The data entry unit 136 may comprise a keyboard, or alternatively a touch-screen. Preferably where a touch-screen is used it comprises an LCD display (not shown).

When the label printer 100 is connected to the PC 120 it reports itself so that the PC is aware of the type of device that has been attached. Such reporting is also known as “enumerating”. The label printer can then function as the type of device it has enumerated itself as.

In an embodiment of the present invention when the label printer 100 is connected to the PC 120 the label printer 100 enumerates as a USB mass storage device, and is recognised as such by the PC. Additionally the label printer enumerates itself as a Human Interface Device (HID). The PC 120 can therefore send data to and receive data from the printer 100 on a HID channel. The communication between the label printer 100 and PC 120 can take place bi-directionally on the HID channel. Preferably this communication is carried out in accordance with the USB-HID protocol. This communication can be carried out without having to install printer drivers first, since the PC will have been pre-configured to communicate using the standardised USB-HID protocol.

The label printer 100 may thus be considered to be in a “plug and play” mode. When in plug and play mode the printer is available for printing basic labels. By “basic” is meant that the number of options available to a user is reduced compared to when operating in “full” printer mode i.e. when the printer drivers have been installed on the PC 120. For example a simplified text editor program is available for the plug and play mode and a full text editor program is used in a full printer mode. The simplified text editor program may provide a subset of the functions of the full text editor or fewer functions as compared to the full text editor. The text editor program may also be known as a label editor program.

In one embodiment the label printer 100 is configured such that when it is connected to the PC 120 it does not automatically enumerate itself as a printer-class device, since as soon as it does so the operating system (OS) on the PC will expect to install or match an existing driver to the newly enumerated device.

Reference is now made to FIG. 2B which shows in more detail label printer Flash storage 130.

To enable the plug and play functionality a software application program 133 is stored on the MSD drive 131 within Flash storage 130. Preferably the software application program 133 is stored on the MSD drive 131 in a compressed manner, which reduces the size and cost of Flash storage (memory) required. In one embodiment the Flash memory has a capacity of 4 MB.

Preferably the software application program comprises a text-editor program. The text-editor program enables a user to create labels to be printed by the label printer.

In one embodiment, to launch the application program 133 a “bootstrapper” or “launcher” application 135 is also provided. This launcher application 135 prepares the main application 133 for use on the PC 120. Alternatively a file can be stored within Flash storage 130 which causes the PC 120 to auto-launch the application program 133.

In use, when the label printer 100 is connected to the PC 120 for the first time the launcher application 135 copies software application program 133 to a hard drive (not shown) on the PC, where it is saved. Where the software application program 133 is stored in a compressed manner, the launcher application 135 enables decompression of the software application program 135. The launcher application 135 then terminates. A user can then operate the label printer 100 in plug and play mode, and create labels to be printed using the text-editor program.

The decompression phase has to be performed only once. If the launcher application 135 detects that the decompressed files are already stored on the PC 120 then the decompression stage is skipped and the software application program 133 is just launched.

In one implementation the files are compressed using the Microsoft® Cabinet files library. This supports the LZX algorithm, which is a known compression algorithm that provides an optimum compression ratio. Preferably it is used with the maximum compression setting available.

In one embodiment the compressed files are stored inside the launcher application 135 as a resource, so there is only one file visible to the user. Such a file name could be, for example, “DYMO Label Light.exe”.

Once decompressed the files are stored in a temporary folder on the hard drive of the PC 120. A typical path name for the temporary folder would be TEMP\DymoLabelLight\<version>folder, where “TEMP” is a user specific temporary folder, and “<version>” is the application version, for example “1.0.0.123”. Preferably this folder is available for read/write access even for limited rights user accounts. In one embodiment this folder is hidden.

As stated above the decompression phase only needs to be performed once, since the launcher application 135 is capable of detecting whether all files stored on the hard drive of the PC to which the label printer 100 is connected are exactly the same as those in the compressed application program 133. The launcher application 135 also checks whether any decompressed applications stored on the PC are corrupted. To check file validity the launcher application 135 calculates an MD5 checksum for all files (in other words all files are looked at as one big file), then that checksum is compared with those for the compressed files the launcher application 135 contains. If the checksum is different then the compressed files are decompressed and replace the existing corresponding files on the PC's hard drive.

The main application program 133 needs to know the flash drive letter, so that a determination can be made as to which printer to print to in case multiple printers are connected within a network. To this end the launcher application 135 passes the drive letter it is running from, followed by the letter itself e.g. “DymoLabelLight.exe/deviceDrive d:”.

By compressing the application program 133 on the MSD drive 131, it is possible to make the application size approximately double what is possible without compression, so far more features can be implemented into the application. This is particularly advantageous in the preferred embodiment where the application program 133 comprises a text-editor program, as this gives a user additional label editing features than would otherwise be available if the application was not compressed.

Preferably the Flash storage 130 is read-only, which minimises the chance of the software application program 133 and launcher application 135 becoming corrupted.

As a further advantage, this method of compressing and subsequently decompressing the software application program 133 and saving it to the memory of the PC 120 minimises the risk of the application crashing during use. For example in Windows®, if the PC 120 needs to get a resource or other item from the software application program 133, it may try to read from the file on the MSD 131. Ordinarily if a user then unplugs the label printer with the application running the application may crash since the PC can no longer access the MSD 131 on the label printer 100. However in this embodiment, since the software application program 133 has been copied to the memory of the PC, it can be read whenever needed and crashing of the application may be avoided.

Once the plug and play application is up and running a user may be presented, on a display of the PC 120, with a user interface 140 as shown in FIG. 3. This is the so-called text-editor program.

Via this user interface 140 a user can design labels and save labels they have created. A number of actions are available to a user.

For example by clicking on icon 142 a user is presented with a blank new label 150, ready for editing.

By clicking on icon 144 a user can paste data stored on their clipboard into a label.

By clicking on icon 146 a user can undo a previous action.

By clicking on icon 148 a user can make a screen grab of data on a display of their PC, which is then pasted directly into the displayed label 150.

By clicking on icon 152 a user can switch between a horizontal and vertical label format.

By clicking on icon 154 a user can add or remove a label border.

By clicking on icon 156 a user can change certain options, such as the language and units of measure.

By clicking on icon 158 a user is connected to the Internet from where the full label printer drivers can be installed.

By clicking on icon 160 a user can change font type.

By clicking on icon 162 a user can change the width of the label.

By clicking on icon 164 a user can change the length of the label or set the label length to automatically adjust to the text inputted.

By clicking on icon 166 a user can set the number of copies of a label to be printed.

By clicking on icon 168 a user can cause a label to be printed.

The icon 170 displays to a user the battery power level of the label printer.

As stated above, in one embodiment when acting as a plug and play printer the USB connection comprises a USB-HID connection. In an embodiment the USB-HID connection operates at a maximum bandwidth of 64 kb/s. Based upon the command received over the USB-HID interface the printer can determine whether it is print data to be sent to the print buffer memory 134 for subsequent printing, or a command such as “Return Status” for which the printer 100 is responsible for replying. In a preferred embodiment the print data is sent as a series of commands and that data is acted upon sequentially as it is received.

Advantageously the HID interface requires no drivers beyond what is preinstalled on all major operating systems. In practical terms the maximum bandwidth of 64 kb/s may not be a limitation as the size of typical label file data is far less than 64 kb. In the event that the maximum bandwidth is exceeded, for example in the printing of multiple labels, then an appropriate message can be provided to the user. In one embodiment commands received by the USB-HID interface are placed in a “circular buffer”, with the CPU 128 analyzing and acting on these commands sequentially.

As set out above the printer 100 can be used in plug and play mode which allows the user to produce relatively simple labels. If more complex labels are required, then full printer drivers can be downloaded to the PC 120 so that the full capabilities of the printer 100 can be used. Typically such drivers are provided on a CD packaged with the label printer, or may be downloaded over the Internet.

When the full printer drivers have been installed the printer can be recognised by the PC 120 as a printer-class device, in addition to when in plug and play mode when it is recognised as a mass storage device. When the full printer drivers have been installed a user can use a separate interface to the one shown in FIG. 3 for creating labels. This separate interface provides the user with full label editing facilities.

FIG. 4 shows an embodiment of a user interface 200 available to the user when the full printer drivers have been downloaded. Such a user interface may be made available to a user by clicking on icon 158 on the plug and play interface (see FIG. 3), and then following on-screen instructions to download the drivers.

Like the plug and play user interface 140, the user interface 200 also comprises a text-editor program. The text-editor program has all the features available on user interface 140, plus further features.

By clicking on icon 202 a user is presented with a number of label options available, such as a standard address label 203, a large return address label 204 or a large address label 205.

By clicking on icon 206 a user can access previously saved labels they have created.

By clicking on icon 208 a user can quickly access labels they have recently printed.

By clicking on icon 210 a user is directed to an address book where saved addresses can be accessed. This is particularly useful when creating address labels.

By clicking on icon 212 a user is quickly taken to the label-editor portion of the program.

By clicking on icon 214 a user is directed to a website from where useful information regarding the label printer can be obtained.

By clicking on icon 216 a user can be directed to a market place from where they can buy labels and/or image receiving tape to be used in the label printer 100.

By clicking on icon 218 a user can print a label they have created. The label to be printed is shown in label portion 222 of the user interface. The label displayed 222 is modified on screen in real time as a user makes any changes.

By clicking on icon 220 a user can switch to the plug and play user interface i.e. the user interface of the type shown in FIG. 3.

A scenario thus arises in which, if the full printer drivers have been installed, the printer 100 can be used as a plug and play printer or as a normal printer device (otherwise known as a printer-class device).

The table below shows the recommended enumeration modes for the printer 100 when connected to the PC 120. By “enumeration” is meant the way in which the printer 100 reports itself to, and is therefore recognised by, the PC 120. The label printer can then function as per that enumeration.

TABLE 1
Printer Device Enumeration

| Mode | Descriptor 1 | Descriptor 2 | Descriptor 3 |
|---|---|---|---|
| Printer | MSD | HID | Printer-class device |
| (enumeration 1) | | | |
| Plug and play | MSD | HID | |
| (enumeration 2) | | | |

Referring to the above:
(a) The MSD device drive is always available, both for loading the plug and play software (which may be compressed), as well as for downloading data for the device to use when untethered.
(b) The HID connection serves as a separate bi-directional communications channel for commands, print data and firmware upgrades.
(c) The Printer-class device is available when a command is sent over the HID channel to turn on the Printer-Class device to allow the use of the full text-editor software and printer drivers.

When in “Printer” mode, the printer 100 is enumerated and functions as a mass storage device (MSD), a human interface device (HID), and a printer. Thus a user can use the printer as a plug and play printer and/or as a printer-class device.

For example the user might have open on the screen of their PC 120 the plug and play user interface such as the one shown in FIG. 3, and may also have open the “full” user interface 200 as a result of downloading the printer drivers. The user can selectively print through the printer 100 using either of these user interfaces without the need to switch the printer between a plug and play mode and a printer mode, since both modes are always present.

For example the user may have a certain label saved via the plug and play user interface 140 which they wish to print, and the user will therefore print that label using the plug and play user interface. The same user may then decide that they want to create a more complex label and therefore will open up the full printer user interface 200, and print a second label using that interface. During the printing of these first and second labels the user has not had to switch the printer between a plug and play mode and a full printer mode, since both modes are always present.

FIG. 5 shows a Windows® Device Manager Hierarchy when a label printer according to the present invention is connected to a PC. At 137 is shown the driver on the PC for USB hardware. At 139 is shown the connection to the PC of a USB Composite Device, in this case label printer 100. At 141 it is clearly shown that the label printer 100 is recognised as both a Human Interface Device and a Mass Storage Device.

FIG. 6 shows the Windows® Device Manager Hierarchy when a label printer according to the present invention is connected to a PC, and the printer drivers have been installed. As shown at 180, the label printer is recognised as a Human Interface Device, a Mass Storage Device and a Printing Support (otherwise known as a printer-class device).

The printer 100 may be connected to a network of PCs (not shown). In such a scenario a PC to which the printer 100 is attached may print using the plug and play mode or full printer mode, while one or more other PCs in the network can print in plug and play mode, or one or more other PCs in the network can print in full printer mode, or one printer in the network can print through the printer using the plug and play mode whereas another printer within the network can print using the full printer mode. Again, there is no need to switch the printer between the plug and play mode and the printer mode, since both modes are always present.

When printing in full printer mode, the print data is sent to the printer 100 using a channel or “USB Endpoint” created when enumerating the printer as a printer-class device, and this channel exists alongside the HID channel or USB Endpoint created when the device was also enumerated as a HID device.

As shown in Table 1, when in plug and play mode the device is enumerated by the PC as an MSD and a HID. In this mode the printer can print using the plug and play user interface shown in FIG. 3, with communication between the printer 100 and the PC 120 taking place on a HID channel.

Enumeration of the label printer 100 according to an embodiment of the present invention is shown in FIG. 7.

At step 400 the label printer 100 is either powered up or plugged in to the PC 120. At this point the PC 120 recognises that hardware (the label printer 100) has been connected, and enumerates the label printer as a Mass Storage Device (MSD) and a Human Interface Device (HID) at step 402.

At step 404 a determination is made as to whether a printer “service” has been installed. The “service” is a small program that is separate from the drivers and application, and it is installed on the user's PC when they install the full application and printer drivers. The service connects itself to the operating system in such a way that it is alerted to the presence of a new hardware device enumeration. If the enumeration is for a plug and play printer, then it assumes that the drivers are present and sends a command to the printer via the HID connection telling the printer to enumerate as HID plus MSD plus Printer (see table 1).

If the determination at step 404 is “No” then the process continues to step 406 where the enumeration is completed and the label printer is considered by the PC as an MSD, ready to use the plug and play software.

If on the other hand the determination at step 404 is “Yes”, then the process continues to step 408 where the “service” recognises the attachment of the label printer device, and a check is then made at step 410 as to whether the “proper” (i.e. full) drivers have been installed.

In one embodiment step 410 can be skipped, since in that embodiment it can be assumed that if the “service” has been installed then the drivers have also been installed.

If the determination at step 410 is “No”, then the process continues to step 406 in which the label printer is recognised by the PC as an MSD, ready to use the plug and play software.

If on the other hand the determination at step 410 is “Yes”, then at step 412 a command is sent from the PC 120 to the label printer 100 to switch the label printer to “printer” mode. In this case the device re-enumerates at step 414 as a printer device. At step 416 the enumeration is complete and the printer's full functionalities can be used.

The aforementioned is by way of example only, and alternative embodiments are possible which remain within the scope of the present invention. For example the CPU 128 may comprise a single processor or multiple processors. The Flash storage 130 may comprise a single memory unit or multiple memory units. Any other memory or memories described in the preferred embodiment may comprise one or more memories. The memory can be Flash memory and/or any other suitable type of memory.

1. A label printer comprising:
a connector configured to allow said label printer to be connected to a PC;
at least one memory;
at least one processor;
said label printer being configured to function as a Human Interface Device (HID) when connected to said PC;
wherein said label printer is configured for bi-directional communication with said PC on a HID channel; and
wherein said label printer is configured to send information relating to a supply of image receiving tape mounted in said label printer on said HID channel.

2. A label printer as set forth in claim 1 wherein said label printer is configured to function as a Human Interface Device upon connection of said label printer to said PC.

3. A label printer as set forth in claim 1, wherein said label printer is further configured to function as a mass storage device (MSD) drive when connected to said PC.

4. A label printer as set forth in claim 3 wherein said MSD drive is comprised in said at least one memory.

5. A label printer as set forth in claim 1 wherein said at least one memory comprises Flash memory.

6. A label printer as set forth in claim 1, wherein said information on said HID channel comprises print data.

7. A label printer as set forth in claim 6, wherein said print data received via said HID channel is created using a first text-editor program.

8. A label printer as set forth in claim 7, wherein said label printer is configured to print said print data received via said HID channel.

9. A label printer as set forth in claim 1 wherein said information comprises a firmware update.

10. A label printer as set forth in claim 1, wherein said label printer is configured to send label printer information to said PC on said HID channel.

11. A label printer as set forth in claim 10, wherein said information to be sent to said PC comprises information relating to a cassette holding said supply of image receiving tape.

12. A label printer as set forth in claim 11, wherein said cassette information comprises information as to whether said cassette has been properly loaded in said label printer.

13. A label printer as set forth in claim 11, wherein said cassette information comprises a width of said image receiving tape.

14. A label printer as set forth in claim 1, wherein said label printer is further configured to function as a printer-class device.

15. A label printer as set forth in claim 14, wherein said label printer is configured to receive print data via a printer-class device channel.

16. A label printer as set forth in claim 14, wherein said label printer functions as said Human Interface Device and said printer-class device based upon an instruction received from said PC.

17. A label printer as set forth in claim 1 wherein, dependent on the presence of a predetermined instruction in the PC, said label printer functions as one of:
a Human Interface Device; a Human Interface Device and a printer class device.

18. A label printer as set forth in claim 1, wherein said connector comprises a USB port.

19. A system comprising a PC and a label printer as set forth in claim 1.

20. A method of operating a label printer comprising:
Configuring said label printer to function as a Human Interface Device (HID) when connected to a PC;
configuring said label printer for bi-directional communication with said PC an a HID channel;
sending information from said label printer relating to a supply of image receiving tape mounted in said label printer on said HID channel.
